(19) United States
(12) Patent Application Publication
(10) Pub. No.: US 2008/0266469 A1
(43) Pub. Date: Oct. 30, 2008

(54) LIQUIID CRYSTAL ON SILICON (LCOS) DISPLAY AND PACKAGE THEREOF

(75) Inventors: Kuei-Hsiang Chen, Tainan County (TW); Lin-Kai Bu, Tainan County (TW)

Correspondence Address: J C PATENTS, INC., 4 VENTURE, SUITE 250, IRVINE, CA, 92618, US

(73) Assignee: HIMAX TECHNOLOGIES LIMITED, Tainan County (TW)

(21) Appl. No.: 11/951,563

(22) Filed: Dec. 6, 2007

Related U.S. Application Data
(60) Provisional application No. 60/914,043, filed on Apr. 26, 2007.

(51) Int. Cl. G02F 1/133; G09G 3/36

(52) U.S. Cl. 349/1; 349/150; 349/151

(57) ABSTRACT

The present invention provides a LCOS display. The display comprises a first PCB, an interface module, a first silicon chip, and a flat cable. The interface module is disposed on the first PCB and used to receive an audio and video signal. The first silicon chip comprises a display area, a processing area, and a metal layer. The display area comprises a pixel array in a LCOS panel formed on the first silicon chip. The processing area comprises a processing unit formed on the first silicon chip. The metal layer is formed on the first silicon chip for electrically connecting the display area with the processing area. The flat cable is used to electrically connect the interface module with the processing unit.

### CROSS-REFERENCE TO RELATED APPLICATION

This application claims the priority benefit of U.S.A. provisional application Ser. No. 60/914,043, filed on Apr. 26, 2007. The entirety of the above-mentioned patent application is hereby incorporated by reference herein and made a part of this specification.

### BACKGROUND OF THE INVENTION

1. Field of Invention

The present invention generally relates to a liquid crystal display (LCD), and more particularly to a liquid crystal on silicon (LCOS) display and package thereof.

2. Description of Prior Art

FIG. 1A is a block diagram of an LCOS display 100. The LCOS display 100 comprises a LCOS panel 103, an audio and video (A/V) system board 102, and an input and output (I/O) connector board 101. The I/O connector board 101 is electrically connected to the A/V system board 102 via a signal cable 104, and the A/V system board 102 is electrically connected to the LCOS panel 103 via a FPC cable 105. The I/O connector board 101 is used to receive an A/V signal. The A/V system board 102 is used to perform the audio and video processing for the A/V signal. The LCOS panel 103 is used to display according to the processed A/V signal.

FIG. 1B is a detail block diagram of the LCOS display 100. The I/O board 101 comprises plural connectors, such as a serial connector 1010, an A/V connector 1011, and a peripheral connector 1012. The A/V connector 1011 is for example a Digital Visual Interface (DVI) connector, a D-subminiature (DSUB) connector, or a composite video connector. The serial connector 1010 is for example a serializer/deserializer (SERDES).

The A/V system board 102 for example comprises a video processor 1020, an audio processor 1021, an audio amplifier 1022, a memory unit 1023 and a peripheral circuit controller 1024. The video processor 1020 performs an image processing on an image signal within the A/V signal. The audio processor 1021 performs an audio processing on an audio signal within the A/V signal. The audio amplifier 1022 amplifies the processed audio signal and transmits the amplified audio signal to the I/O connector board 101 via the signal cable 104.

The memory unit 1023 stores data for the video processor 1020 and the audio processor 1021. The memory unit 1023 may be a dynamic random access memory (DRAM) and/or a read only memory. The peripheral circuit controller 1024 converts a signal from the peripheral connector into a specific signal, wherein the A/V system board 102 performs the signal processing on the specific signal.

The LCOS panel 103 comprises a LCOS chip 1030. The LCOS chip 1030 comprises a timing controller 1033, a gamma circuit 1034, a power circuit 1035, a source driver 1036, a gate driver 1037 and a pixel array 1038 for display.

FIG. 1C is a cross-sectional view diagram of the LCOS display 100. The I/O connector board 101 further comprises a PCB substrate 1013, on which the connectors (only the serial connector 1010 and the A/V connector 1011 are shown for example) are mounted. The A/V system board 102 further comprises a PCB substrate 1026, on which the ICs (only the video processor 1020 and audio processor 1021 are shown for example) are mounted. The video processor 1020, audio processor 1021 and other functions of the A/V system board 102 may be integrated in a single IC. The LCOS chip 1030 is packaged on the FPC 108 and electrically connected to the conductive lines on the FPC 108 by bonding wire 107. The FPC cable 105 extends from the FPC 108. A heatsink 106 is disposed under the LCOS panel 103, thus the heat can dissipate. The LCOS panel 103 further comprises a glass substrate 1031 and a liquid crystal layer 1032.

The conventional LCOS display has a lot of components such that that the manufacturing process is complex and the cost is high.

In order to solve these and other problems as stated above, the embodiments of the invention provides a display for fulfilling system on LCOS and package thereof to decrease the cost and increase the system integration.

### SUMMARY OF THE INVENTION

Accordingly, the present invention is directed to a LCOS display. The display utilizes the spare die area to incorporate more functions for increasing area efficiency and system integration, improving package yield, and decreasing manufacturing cost.

The present invention provides a LCOS display. The display comprises a first PCB, an interface module, a first silicon chip, and a flat cable. The interface module is disposed on the first PCB and used to receive an A/V signal. The first silicon chip comprises a display area, a processing area, and a metal layer. The display area comprises a pixel array in a LCOS panel formed on the first silicon chip. The processing area comprises a processing unit formed on the first silicon chip. The metal layer is formed on the first silicon chip for electrically connecting the display area with the processing area. The flat cable is used to electrically connect the interface module with the processing unit.

It is to be understood that both the foregoing general description and the following detailed description are exemplary, and are intended to provide further explanation of the present invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram of an LCOS display 100.

FIG. 1B is a detail block diagram of the LCOS display 100.

FIG. 1C is a cross-sectional view diagram of the LCOS display 100.

FIG. 2A is a block diagram of the LCOS display 200.

FIG. 2B is cross-sectional view diagram of the first silicon chip 230.

FIG. 2C is a package of the LCOS display 200.

FIG. 3A is a block diagram of the LCOS display 500.

FIG. 3B is a package of the LCOS display 500.

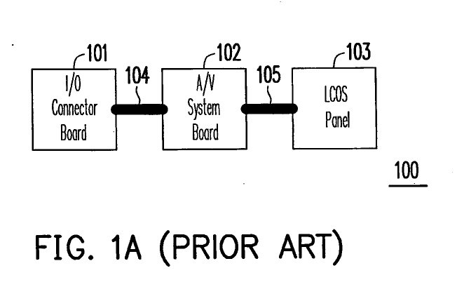

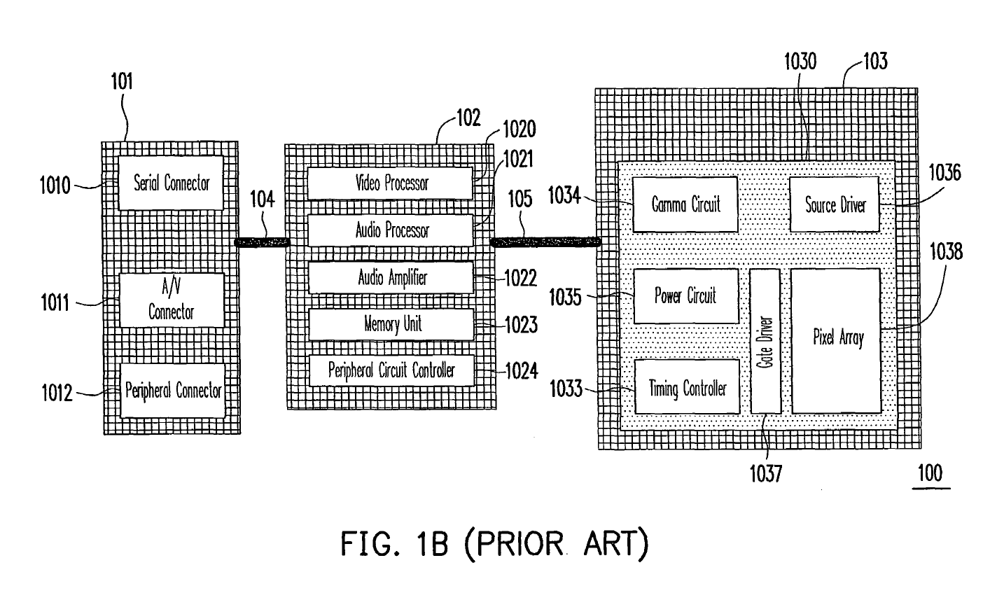

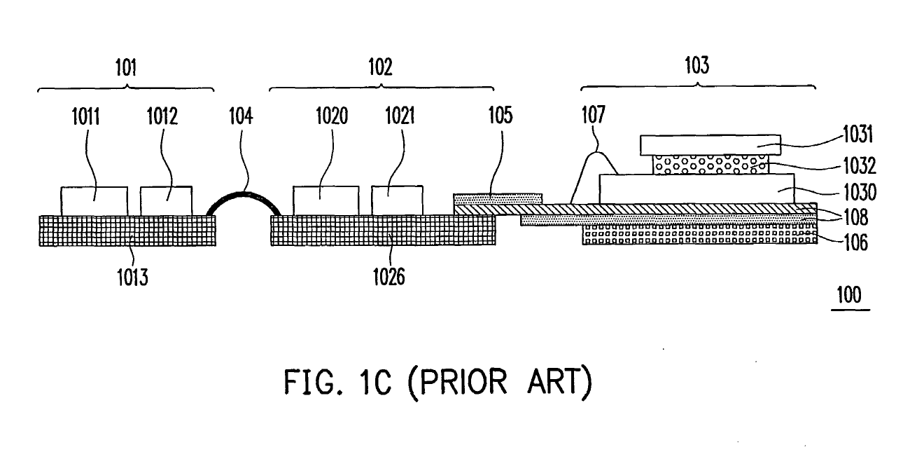

### DESCRIPTION OF THE EMBODIMENTS

Reference will now be made in detail to the present preferred embodiment of the invention, examples of which are illustrated in the accompanying drawings. Wherever possible, the same reference numbers are used in the drawings and the description to refer to the same or like parts.

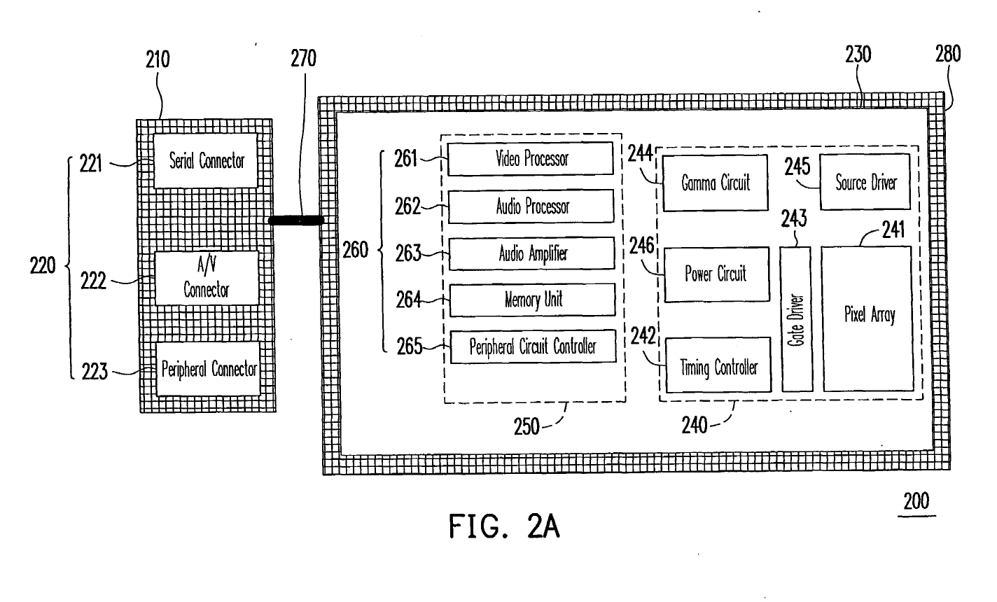

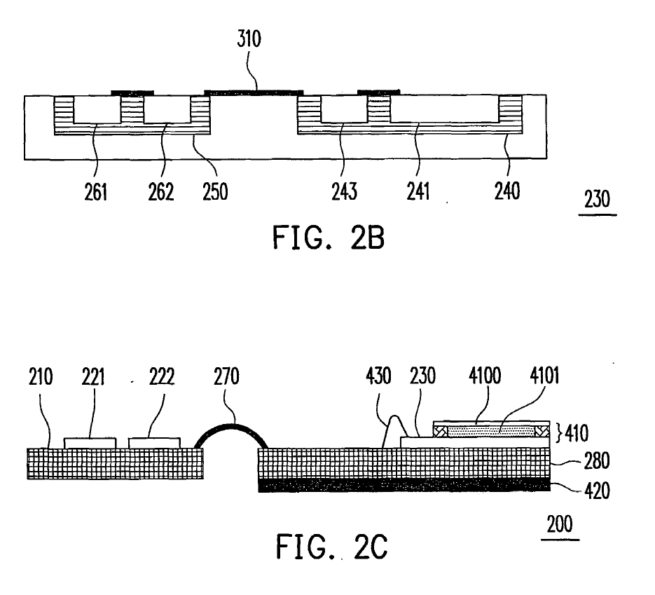

FIG. 2A is a block diagram of the LCOS display 200. The display 200 comprises a PCB 210, an interface module 220, a first silicon chip 230, and a flat cable 270. The interface module 220 is disposed on the PCB 210 and is used to receive an A/V signal. The first silicon chip 230 comprises a display area 240, a processing area 250 and a metal layer 310 (shown in FIG. 2B). The display area 240 comprises a pixel array 241 formed on the first silicon chip 230. The processing area 250 comprises a processing unit 260 formed on the first silicon chip 230. The metal layer 310 is formed on the first silicon chip 230 for electrically connecting the display area 240 with the processing area 250. The flat cable 270 electrically connects the interface module 220 with the processing unit 260. The flat cable 270 is a flexible flat cable or a FPC cable.

The interface module 220 comprises for example a serial connector 221, an A/V connector 222, and a peripheral connector 223. The A/V connector 222 is for example a DVI connector, a DSUB connector, or a composite connector. The peripheral connector 223 is for example a USB connector. Although the interface module 220 is exemplified by the above connectors, not all the above connectors are necessary for the interface module 220, which may include other types of connectors as well.

In this embodiment, the processing unit 260 comprises video processor 261 and an audio processor 262. The video processor 261 processes an image signal within the A/V signal. The audio processor 262 processes an audio signal within the A/V signal. The processing unit 260 may further include an audio amplifier 263, a memory unit 264, and/or a peripheral connector 265. The audio amplifier 263 amplifies the processed audio signal and transmits the amplified audio signal to the interface module 220 via the signal cable 270.

The memory unit 264 stores a data for the video processor 261 and the audio processor 262. The memory unit 265 comprises a DRAM and/or a read only memory (ROM). The peripheral circuit controller 265 converts a signal from the peripheral connector into a specific signal, wherein the processing unit 260 performs the signal processing on the specific signal.

The display area 240 further comprises a timing controller 242, a power circuit 246, a gamma circuit 244, a source driver 245, and a gate driver 243. The timing controller 242 converts a display data from the processing unit 260 to control the source driver 245 and the gate driver 243.. The gamma circuit 244 generates a plurality of gamma reference voltages for the source drivers 245. The power circuit 246 generates power voltages required by the gate driver 243 and the source driver 245.

The first silicon chip 230 is packaged on a PCB substrate 280 having conductive lines. The processing unit 260 is electrically connected to the conductive lines by a first bonding wire 430 (not shown in FIG. 2A, please see FIG. 2C), and the flat cable 270 is electrically connected to the processing unit 260 via the conductive lines.

Please see FIG. 2B, FIG. 2B is cross-sectional view diagram of the first silicon chip 230. The first silicon chip 230 is a system on LCOS chip, which can be also abbreviated to SOL chip. As stated above, the metal layer 310 is formed on the first silicon chip 230 for electrically connecting the display area 240 with the processing area 250. The display area 240 and processing area 250 are integrated into a single chip so as to achieve high system integration and efficient area utilization. Furthermore, the metal 310 replaces the conventional FPC cable, and thus the manufacturing cost decreases.

FIG. 2C is a package of the LCOS display 200. As stated above, the PCB substrate 280 has the conductive lines and the first bonding wire 430, so the processing unit 260 electrically connects to the conductive lines by a first bonding wire 430, and the flat cable 270 is electrically connects to the processing unit 260 via the conductive lines. A heat sink 420 is attached to a back surface of the PCB substrate 280 opposing the first silicon chip 230 so as to prevent the LCOS display 200 from thermal damage.

The LCOS panel 410 comprises an opposite substrate 4100 and a liquid crystal layer 4101. The opposite substrate 4100 is disposed above the LCOS chip 230, and the liquid crystal layer 4101 is disposed between the pixel array 241 of the LCOS chip 230 and the opposite substrate 4100.

Accordingly, the LCOS display 200 improves mechanical connection robustness and the yield rate. Since the display area 240 and processing area 250 are integrated into the first silicon chip 230, it achieves high system integration, and low manufacturing cost. Furthermore, the signals integrity and power consumption efficiency are improved since the wire length is shortened.

The functional blocks of the LCOS display may be not easily integrated into a single chip due to the different semiconductor manufacturing processes. Thus in order to solve this problem, some chips can be integrated on the PCB, and interconnected by a plurality of bonding wires.

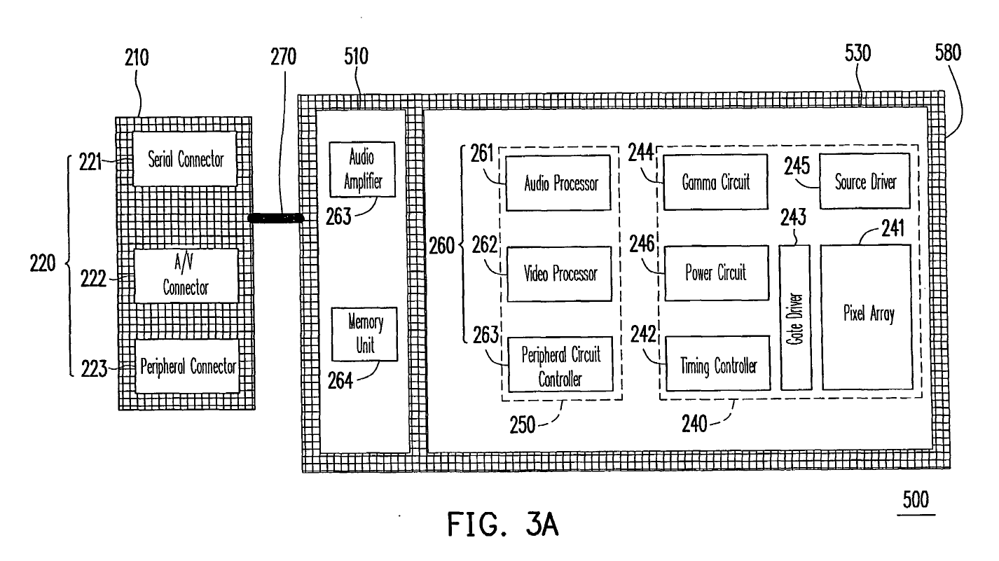

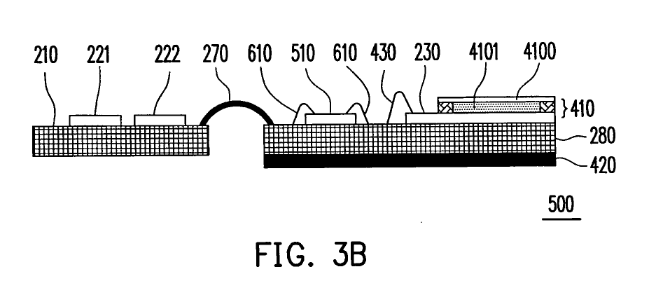

FIG. 3A is a block diagram of the LCOS display 500 according to another embodiment of the invention. The display 500 comprises a PCB 210, an interface module 220, a first silicon chip 530, a second silicon chip 510, and a flat cable 270. The first silicon chip 530 and the second silicon chip 510 are packaged on the same PCB substrate 280 having conductive lines. The second silicon chip 510 comprises the audio amplifier 263 and the memory unit 264, which are formed by semiconductor manufacturing process different from that of elements in the first silicon chip 530.

FIG. 3B is a cross-section view of the LCOS display 500. The first silicon chip 530 and the second silicon chip 510 are packaged on the PCB substrate 280 by the multi-chip packing technology, and electrically connect to the conductive lines of the PCB substrate 280 by the first bonding wires 430 and the second bonding wires 610.

From these embodiments, in the LCOS chip, the pixel array occupies most area of the chip, and other functional blocks only occupy much smaller area. The usage of the chip area is therefore optimized, the system integration is high, and the manufacturing cost is reduced.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An LCOS display comprising:
a first printed circuit board (PCB);
a interface module, disposed on the first PCB, for receiving an audio and video signal; and
a first silicon chip comprising:
a display area comprising a pixel array in a liquid crystal on silicon panel (LCOS panel) formed on the first silicon chip;
a processing area comprising a processing unit formed on the first silicon chip; and
a metal layer formed on the first silicon chip for electrically connecting the display area with the processing area;
a flat cable for electrically connecting the interface module with the processing unit.

2. The display as claimed in claim 1, wherein the first silicon chip is packaged on a PCB substrate having conductive lines, the processing unit is electrically connected to the conductive lines by a first bonding wire, and the flat cable is electrically connected to the processing unit via the conductive lines.

3. The display as claimed in claim 2, further comprising a heat sink attached to a back surface of the PCB substrate opposing the first silicon chip.

4. The display as claimed in claim 2, further comprising:
a second silicon chip, packaged on the PCB substrate and electrically connected to the conductive lines by a plurality of second bonding wires,
wherein the second silicon chip comprises an audio amplifier and a memory unit.

5. The display as claimed in claim 4, wherein the memory unit comprises a dynamic random access memory (DRAM) and a read only memory (ROM).

6. The display as claimed in claim 4, wherein the processing unit comprises:
a video processor, for performing an image processing ; and
an audio processor, for performing an audio processing.

7. The display as claimed in claim 1, wherein the processing unit comprises:
a video processor, for performing an image processing;
an audio processor, for performing an audio processing;
an audio amplifier; and
a memory unit.

8. The display as claimed in claim 7, wherein the memory unit comprises a dynamic random access memory (DRAM) and a read only memory (ROM).

9. The display as claimed in claim 1, wherein the display area further comprises:
a timing controller;
a gate driver, connected to the timing controller;
a gamma circuit, for generating a plurality of gamma reference voltages;
a source driver, connected to the timing controller, the gamma circuit and the pixel array; and
a power circuit, for generating a power voltage required by the gate driver and the source driver.

10. The display as claimed in claim 9, wherein the interface module comprises a serial connector and an audio and video connector.

11. The display as claimed in claim 10, wherein the audio and video connector is a Digital Visual Interface (DVI) connector, a D-subminiature (DSUB) connector, or a composite connector.

12. The display as claimed in claim 1, wherein the interface module further comprises a peripheral connector.

13. The display as claimed in claim 12, wherein the processing unit further comprises:
a peripheral circuit controller, for converting a signal from the peripheral connector into a specific signal, wherein the processing unit performs the signal processing on the specific signal.

14. The display as claimed in claim 12, wherein the peripheral connector is a USB connector.

15. The display as claimed in claim 1, wherein the flat cable comprises a flexible flat cable or a flexible printed circuit (FPC) cable.

16. The display as claimed in claim 1, wherein the LCOS panel comprises:
an opposite substrate disposed above the first silicon chip; and
a liquid crystal layer disposed between the pixel array and the opposite substrate.
